(19) United States
(12) Patent Application Publication
(10) Pub. No.: US 2021/0133399 A1
(43) Pub. Date: May 6, 2021

(54) ANTENNA USAGE AS A USER INTERFACE

(71) Applicant: QUALCOMM Incorporated, San Diego, CA (US)

(72) Inventors: Aline Coelho De Souza, Cambridge (GB); Nicolas Graube, Cambridge (GB); Murray Jarvis, Cambridge (GB); Andrew John Laister, Cambridge (GB); Gerald Miaille, Chandler, AZ (US)

(21) Appl. No.: 16/675,088

(22) Filed: Nov. 5, 2019

(51) Int. Cl. G06K 7/10; G06F 3/01; H04R 1/10; H01Q 1/27

(52) U.S. Cl. CPC G06K 7/10148; H01Q 1/273; H04R 1/1016; G06F 3/017

(57) ABSTRACT

Methods, systems, and devices for wireless communications are described. Generally, the described techniques provide for identifying, by a wearable device, a baseline antenna impedance value, detecting one or more sensor inputs, monitoring for a variation in antenna impedance from the baseline antenna impedance value, identifying a user gesture (e.g., based at least in part on the detected sensor inputs and the variation from the baseline antenna impedance value) at least one user gesture, and updating an operational status of the device based on the detected user gesture.

### BACKGROUND

The following relates generally to wireless communications, and more specifically to antenna impedance variation as a user interface.

A wireless personal area network (PAN), which may include a Bluetooth connection, may provide for short range wireless connections between two or more paired wireless devices. For example, wireless devices such as cellular phones may utilize wireless PAN communications to exchange information such as audio signals with wearable devices, such as wireless earbuds, headsets, watches, health monitors, and the like.

Wearable devices are becoming increasingly sophisticated, but in some cases wearable devices may have restricted limited power budget, and limited physical space (e.g., for user interface). Restricted physical space for a wearable device may result in a limited or decreased number of available buttons and placement opportunities for an available button. Physical buttons on a wearable device may be difficult to operate. A sensitive, reliable button alternative may be beneficial.

### SUMMARY

The described techniques relate to improved methods, systems, devices, and apparatuses that support antenna impedance measurements (e.g., in combination with other sensor inputs) a user interface. Generally, the described techniques provide for identifying, by a wearable device, such as a wireless earbud, a baseline antenna impedance value, detecting one or more sensor input (e.g., motion, physical touch, sound, light, or the like), at the wearable device, monitoring for a variation in antenna impedance from the baseline antenna impedance value, identifying a user gesture (e.g., based at least in part on the detected sensor inputs and the variation from the baseline antenna impedance value) at least one user gesture (e.g., a tapping motion, a tap-and-hold motion, a vertical swipe, a horizontal swipe, putting the wearable device in, removing the wearable device, etc.), and updating an operational status of the device based on the detected user gesture (e.g., turning the device on, turning the device off, adjusting one or more settings of the device, etc.).

A method of detecting user input at a device is described. The method may include identifying a baseline antenna impedance value, detecting one or more sensor inputs at the device, monitoring, based on the detecting, for a variation from the baseline antenna impedance value, identifying, based on the detecting and the monitoring, at least one user gesture, and updating an operational status of the device based on the detected user gesture.

An apparatus for detecting user input at a device is described. The apparatus may include a processor, memory coupled with the processor, and instructions stored in the memory. The instructions may be executable by the processor to cause the apparatus to identify a baseline antenna impedance value, detect one or more sensor inputs at the device, monitor, based on the detecting, for a variation from the baseline antenna impedance value, identify, based on the detecting and the monitoring, at least one user gesture, and update an operational status of the device based on the detected user gesture.

Another apparatus for detecting user input at a device is described. The apparatus may include means for identifying a baseline antenna impedance value, detecting one or more sensor inputs at the device, monitoring, based on the detecting, for a variation from the baseline antenna impedance value, identifying, based on the detecting and the monitoring, at least one user gesture, and updating an operational status of the device based on the detected user gesture.

A non-transitory computer-readable medium storing code for detecting user input at a device is described. The code may include instructions executable by a processor to identify a baseline antenna impedance value, detect one or more sensor inputs at the device, monitor, based on the detecting, for a variation from the baseline antenna impedance value, identify, based on the detecting and the monitoring, at least one user gesture, and update an operational status of the device based on the detected user gesture.

In some examples of the method, apparatuses, and non-transitory computer-readable medium described herein, identifying the at least one user gesture may include operations, features, means, or instructions for identifying, based on the detecting, a user gesture hypothesis, and confirming, based on the monitoring, the user gesture hypothesis.

Some examples of the method, apparatuses, and non-transitory computer-readable medium described herein may further include operations, features, means, or instructions for transmitting one or more -radio frequency signals using a first antenna, where the monitoring may be based on the first antenna, where the monitoring includes measuring a current antenna impedance value for the first antenna, and comparing the current antenna impedance value to the baseline antenna impedance value, where identifying the at least one user gesture may be based on the comparing.

In some examples of the method, apparatuses, and non-transitory computer-readable medium described herein, identifying the baseline antenna impedance value further may include operations, features, means, or instructions for performing one or more antenna impedance measurements during a period of time at a first antenna to dynamically identify the baseline antenna impedance value.

In some examples of the method, apparatuses, and non-transitory computer-readable medium described herein, identifying the baseline antenna impedance value further may include operations, features, means, or instructions for identifying a preconfigured baseline antenna impedance value.

Some examples of the method, apparatuses, and non-transitory computer-readable medium described herein may further include operations, features, means, or instructions for performing one or more antenna impedance measurements during a period of time, and adjusting the preconfigured baseline antenna impedance value based on the one or more antenna impedance measurements.

In some examples of the method, apparatuses, and non-transitory computer-readable medium described herein, monitoring for the variation from the baseline antenna impedance value may include operations, features, means, or instructions for performing one or more antenna impedance measurements, where identifying the one or more user gesture may be based on the one or more antenna impedance measurements.

In some examples of the method, apparatuses, and non-transitory computer-readable medium described herein, monitoring for the variation from the baseline antenna impedance value may include operations, features, means, or instructions for detecting one or more antenna impedance compensation actions taken by the device, and determining that the one or more antenna impedance compensation actions indicate a change in a current measured antenna impedance, where identifying the one or more user gesture may be based on the determining.

In some examples of the method, apparatuses, and non-transitory computer-readable medium described herein, the one or more antenna impedance compensation actions taken by the device include an adjusted power setting at the device.

In some examples of the method, apparatuses, and non-transitory computer-readable medium described herein, detecting the one or more sensor inputs may include operations, features, means, or instructions for detecting one or more of an audio input, a physical touch, a rotation, or an acceleration, using one or more of a microphone, a speaker, a sensor, a gyroscope, or an accelerometer.

In some examples of the method, apparatuses, and non-transitory computer-readable medium described herein, the one or more user gesture includes one or more of a tapping motion, a tap-and-hold motion, inserting the device, removing the device, a vertical swipe, or a horizontal swipe.

### BRIEF DESCRIPTION OF THE DRAWINGS

FIG. 1 illustrates an example of a system for wireless communications that supports antenna usage as a user interface in accordance with aspects of the present disclosure.

FIG. 2 illustrates an example of a gesture detection scenario that supports antenna usage as a user interface in accordance with aspects of the present disclosure.

FIG. 3A illustrates an example of a user gesture that supports antenna usage as a user interface in accordance with aspects of the present disclosure.

FIG. 3B illustrates an example of a user gesture that supports antenna usage as a user interface in accordance with aspects of the present disclosure.

FIGS. 4 and 5 show block diagrams of wearable devices that support antenna usage as a user interface in accordance with aspects of the present disclosure.

FIG. 6 shows a block diagram of a gesture detection manager that supports antenna usage as a user interface in accordance with aspects of the present disclosure.

FIG. 7 shows a diagram of a system including a device that supports antenna usage as a user interface in accordance with aspects of the present disclosure.

FIGS. 8 and 9 show flowcharts illustrating methods that support antenna usage as a user interface in accordance with aspects of the present disclosure.

### DETAILED DESCRIPTION

In some examples, a user may utilize a wearable device (e.g., a wireless communication device, wireless headset, earbud, speaker, hearing assistance device, health monitor, or the like), and may wear the device to make use of it in a hands-free manner. Some wearable devices may include one or more sensors attached on the outside, inside, or both of the device. The sensor may include, for example, a speaker, a microphone, an accelerometer, a gyroscope, a light sensor, a proximity sensor, or the like. Some wearable devices may include one or more antennas for transmitting or receiving wireless signals, audio signals, or the like. For example, a wearable device may communicate bidirectionally with a host cellular device over a Bluetooth connection using one or more antennas. Additionally, two wearable devices may communicate with each other using the one or more antennas. The wearable device may be small and easy to use or wear, but may have limited power budget, and limited physical space (e.g., for user interface). Restricted physical space for a wearable device may result in a limited or decreased number of functioning buttons. The limited number of physical buttons on a wearable device may be difficult to operate. A sensitive, reliable button alternative may be beneficial.

A hearable device may use changes in measured antenna impedance to avoid the need for a button and/or proximity sensor. In some examples, the wearable device may use changes in measured antenna impedance to augment other gesture detection systems to improve performance (e.g., avoid false positive identifications of user gestures). That is, a button may have on/off capabilities as well as the ability to present sequencing with variable delays between inputs. Impedance variations may confirm such capabilities. Additionally, some operations (e.g., such as tap detections) may be ambiguously detected by one or more sensors and disambiguated through antenna impedance variation measurements. For instance, the device may use an accelerometer as a reasonable user gesture detector (e.g., button alternative) but reliance on the accelerometer may result in a large number of false alarms. Accuracy of gesture detection may be improved (e.g., false positives from accelerometer measurements may be significantly reduced) by confirming a user gesture hypothesis with an antenna impedance measurement.

Aspects of the disclosure are initially described in the context of a wireless communications system. Aspects of the disclosure are further illustrated by and described with reference to gesture detection scenarios and user gestures. Aspects of the disclosure are further illustrated by and described with reference to apparatus diagrams, system diagrams, and flowcharts that relate to antenna usage as a user interface.

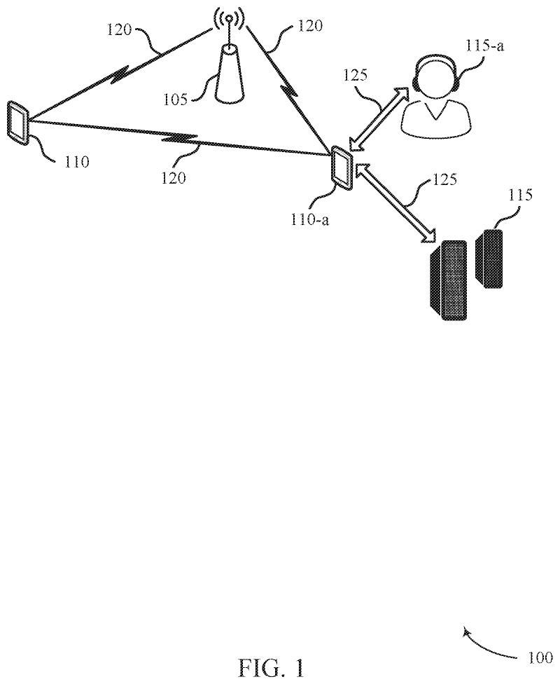

FIG. 1 illustrates an example of a wireless communications system 100 that supports antenna usage as a user interface in accordance with aspects of the present disclosure. In some examples, the wireless communications system 100 may include or refer to a wireless personal area network (PAN), a wireless local area network (WLAN), a Wi-Fi network) configured in accordance with various aspects of the present disclosure. The wireless communications system 100 may include an access point (AP) 105, devices 110 (e.g., which may be referred to as source devices, master devices, host devices, etc.), and paired wearable devices 115 (e.g., which may be referred to as sink devices, slave devices, etc.) implementing WLAN communications (e.g., Wi-Fi communications) and/or Bluetooth communications. For example, devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired wearable devices 115 may include Bluetooth-enabled devices capable of pairing with other Bluetooth-enabled devices (e.g., such as devices 110), which may include wireless audio devices (e.g., headsets, earbuds, speakers, ear pieces, headphones), display devices (e.g., TVs, computer monitors), microphones, meters, valves, etc.

Bluetooth communications may refer to a short-range communication protocol and may be used to connect and exchange information between devices 110 and paired wearable devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a master-slave relationship employing a time-division duplex protocol having, for example, defined time slots of 625 mu seconds, in which transmission alternates between the master device (e.g., a device 110) and one or more slave devices (e.g., paired wearable devices 115). In some examples, a device 110 may generally refer to a master device, and a paired wearable device 115 may refer to a slave device in the wireless communications system 100. As such, in some examples, a device may be referred to as either a device 110 or a paired wearable device 115 based on the Bluetooth role configuration of the device. That is, designation of a device as either a device 110 or a paired wearable device 115 may not necessarily indicate a distinction in device capability, but rather may refer to or indicate roles held by the device in the wireless communications system 100. Generally, device 110 may refer to a wireless communication device capable of wirelessly exchanging data signals with another device (e.g., a paired wearable device 115), and paired wearable device 115 may refer to a device operating in a slave role, or to a short-range wireless communication device capable of exchanging data signals with the device 110 (e.g., using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (e.g., roles for a device 110 and a paired wearable device 115) that together form a single use case called a profile (e.g., for communications between the device 110 and the paired wearable device 115). One example profile defined in the Bluetooth specification is the Handsfree Profile (HFP) for voice telephony, in which one device (e.g., a device 110) implements an Audio Gateway (AG) role and the other device (e.g., a paired wearable device 115) implements a Handsfree (HF) device role. Another example is the Advanced Audio Distribution Profile (A2DP) for high-quality audio streaming, in which one device (e.g., device 110) implements an audio source device (SRC) role and another device (e.g., paired wearable device 115) implements an audio sink device (SNK) role.

For a commercial Bluetooth-enabled device that implements one role in a profile to function properly, another device that implements the corresponding role may be present within the radio range of the first device. For example, in order for a wearable device such as a Bluetooth headset to function according to a Handsfree Profile, a device implementing the AG role (e.g., a cell phone) may have to be present within radio range. Likewise, in order to stream high-quality mono or stereo audio according to the A2DP, a device implementing the SNK role (e.g., Bluetooth headphones or Bluetooth speakers) may have to be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (e.g., flow control, acknowledgement mechanisms, repeat mechanisms, sequence numbering, scheduling behavior, etc.). The Bluetooth protocol stack may be split in two parts: a controller stack including the timing critical radio interface, and a host stack handling high level data. The controller stack may be generally implemented in a low cost silicon device including a Bluetooth radio and a microprocessor. The controller stack may be responsible for setting up connection links 125 such as asynchronous connection-less (ACL) links, (or ACL connections), synchronous connection orientated (SCO) links (or SCO connections), extended synchronous connection-oriented (eSCO) links (or eSCO connections), other logical transport channel links, etc.

In some examples, the controller stack may implement link management protocol (LMP) functions, low energy link layer (LELL) functions, etc. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, service discovery protocol (SDP) functions, etc. In some examples, the controller stack and the host stack may communicate via a host controller interface (HCI). In other cases, (e.g., for integrated devices such as Bluetooth headsets), the host stack and controller stack may be run on the same microprocessor to reduce mass production costs. For such host-less systems, the HCI may be optional, and may be implemented as an internal software interface.

A connection link 125 may be established between two Bluetooth-enabled devices (e.g., between a device 110 and a paired wearable device 115) and may provide for communications or services (e.g., according to some Bluetooth profile). For example, a Bluetooth connection may be an eSCO connection for voice call (e.g., which may allow for retransmission), an ACL connection for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., paired wearable device 115) are acknowledged, and may be retransmitted if not acknowledged during a retransmission window. In addition, audio may be streamed between a device 110 and a paired wearable device 115 using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 110 may support WLAN communications via AP 105 (e.g., over communication links 120). The AP 105 and the associated devices 110 may represent a basic service set (BSS) or an extended service set (ESS). The various devices 110 in the network may be able to communicate with one another through the AP 105. In some cases, the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within wireless communications system 100, and devices may communicate with each other via communication links 120 (e.g., Direct connections, Wi-Fi Tunneled Direct Link Setup (TDLS) links, peer-to-peer communication links, other peer or group connections). AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (e.g., the communication link from the AP 105 to the device 110) and uplink (e.g., the communication link from the device 110 to the AP 105).

In some examples, content, media, audio, etc. exchanged between a device 110 and a paired wearable device 115 may originate from a WLAN. For example, in some examples, device 110 may receive audio from an AP 105 (e.g., via WLAN communications), and the device 110 may then relay or pass the audio to the paired wearable device 115 (e.g., via Bluetooth communications). In some examples, certain types of Bluetooth communications (e.g., such as high quality or high definition (HD) Bluetooth) may require enhanced quality of service. For example, in some examples, delay-sensitive Bluetooth traffic may have higher priority than WLAN traffic.

Generally, the described techniques provide for identifying, by a wearable device, a baseline antenna impedance value, detecting one or more sensor inputs (e.g., motion, physical touch, sound, light, or the like), at the wearable device, monitoring for a variation in antenna impedance from the baseline antenna impedance value, identifying a user gesture (e.g., based at least in part on the detected sensor inputs and the variation from the baseline antenna impedance value) at least one user gesture (e.g., a tapping motion, a tap-and-hold motion, a vertical swipe, a horizontal swipe, putting the wearable device in, removing the wearable device, etc.), and updating an operational status of the device based on the detected user gesture (e.g., turning the device on, turning the device off, adjusting one or more settings of the device, etc.).

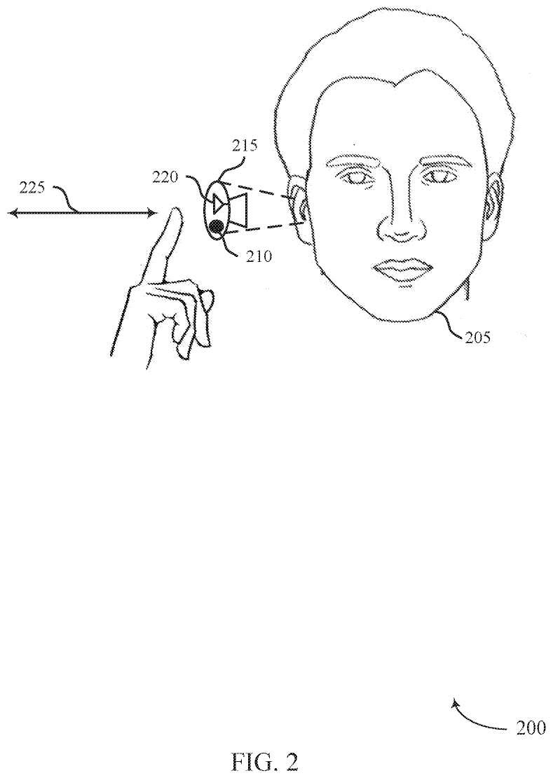

FIG. 2 illustrates an example of a user gesture detection scenario 200 that supports antenna usage as a user interface in accordance with aspects of the present disclosure. In some examples, user gesture detection scenario 200 may implement aspects of wireless communication system 100.

In some examples, a user 205 may use a wearable device 215. Wearable device 215 may include one or more sensors 210 and an antenna 220. The one or more sensors 210 may be a microphone, a speaker, a light sensor, a proximity sensor, a gyroscope, an accelerometer, or the like. Antenna 220 may transmit or receive one or more signals 225 (e.g., a wireless signal, an audio signal, etc.). Antenna 220 may be bidirectional, and may be used for transmitting or receiving signals 225. Antenna 220 may convert the received signal 225 from a radiated electromagnetic wave to a guided electromagnetic signal. Antenna impedance at antenna 220, a complex parameter that can be translated in magnitude and phase, may be defined as an ohmic resistance and reactance to an electromagnetic signal at antenna terminals 220. Antenna impedance may be affected by the environment in which antenna 220 is located. For instance, antenna 220 may be located in the main body of a wireless wearable device 215. Antenna 220 may be highly sensitive to its surrounding environment, such that the proximity effect of the human body (e.g., a and, a finger, an ear, etc.) or the electromagnetic characteristics of a charging case material, or the like, may affect antenna 220 differently and cause changes in antenna impedance. Antenna 220 may be designed for optimal performance in specific environments (e.g., in the ear of antenna 220, in a charging case, etc.), and may be generally mismatched for all other environments. That is, a radio may be tuned to receive wireless signals 225. When an environment of the antenna 220 changes (e.g., wearable device 215 is put into the ear of user 205, removed from the ear of user 205, tapped, swiped, charged, etc. (, the radio is detuned by a predictable extent. When a user 205 performs a user gesture, the antenna impedance of antenna 220 may change. Thus, user gestures may be detected or confirmed by monitoring antenna impedance.

In some examples, wearable device 215 may have one or more buttons. However, button may take up valuable and limited physical space. Furthermore, buttons may be unreliable or may not be consistent in correctly interpreting user gestures. In some cases, physical buttons may consume excessive power, or may be difficult to operate, or may be otherwise inefficient (e.g., each button may have only one input).

In some examples, one or more sensors 210 may be capable of sensing one or more user gestures (e.g., by detecting one or more sensor inputs). For instance, user 205 may tap wearable device 215. If one or more sensors 210 are photosensitive, then the change in light input due to the touch of a finger by user 205 may be detected. If one or more sensor 210 are microphones or speakers operating in a microphone mode, then the tap of the finger may be detected (e.g., via sensor inputs due to sound waves). If one or more sensors 210 are examples of an accelerometer, then the one or more sensors 210 may detect motion (e.g., wearable device 215 may move if tapped, or may be in motion when being input or removed from the ear of user 205). If the one or more sensors 210 are examples of a gyroscope, then the one or more sensors 210 may detect rotational movement (e.g., when being input or removed from the ear of user 205). If the one or more sensors 210 are examples of a proximity sensor or a motion sensor, then the one or more sensors 210 may detect a tapping or touching motion made by user 205. However, one or more sensors 210 may be prone to falsely identify user gestures. For instance, if sensor 210 is a proximity sensor, then it may falsely detect a user gesture if wearable device 215 is placed in a bag or in a pocket. If sensor 210 is photosensitive, then other hand gestures, passing objects, changes in lighting, being placed in a pocket, or the like, may be interpreted as a tap or other user gesture. If sensor 210 is an accelerometer, the sensor 210 may falsely detect one or more sensor inputs and may interpret them as a user gesture. Similar false-positive scenarios may arise for any kind of sensor 210 (e.g., a gyroscope, a speaker, etc.). Any amount of false alarms or falsely detected user gestures may be irritating or otherwise decrease user experience (e.g., a user may be listening to music, and the music may be erroneously paused based on a falsely detected user gesture, which may be annoying to the user). Because any interruption to user experience due to falsely detected user gesture decreases user experience, a conventional sensor system that results in such falsely detected user gestures may be insufficient. A method for augmenting the reliability of user gesture detection may decrease the false alarm rate to an exceedingly low level.

In some examples, wearable device 215 may detect changes in antenna impedance, and may detect user gestures based thereon (e.g., alone, or in combination with sensor inputs detected by sensor 210). For instance, wearable device 215 may detect, via sensor 210, a tapping motion by user 205. Wearable device 215 may develop a user gesture hypothesis based on the sensing (e.g., the user is tapping wearable device 215). To ensure that the hypothesis is true (e.g., to avoid false positives), wearable device 215 may confirm the user gesture hypothesis based on antenna impedance. If an antenna impedance variation is also detected via antenna 220, then wearable device 215 may identify, with a high degree of confidence, the user gesture (e.g., the tapping motion). In some examples, use of impedance variations to detect user gestures may result in increased flexibility at wearable device 215. That is, some gestures that could not otherwise be detected (e.g., by a proximity sensor that could only sense a tap) may be detected using antenna impedance variations. For instance, a proximity sensor or accelerometer may be unable to sense the difference between a tap and a tap-and-hold motion by user 205. Tap-and-hold gesture detection may be particularly valuable for voice UI interfaces where knowing the duration of speaking allows for more rapid responses from a server, which may improve user experience. In some examples, wearable device 215 may use antenna 220 for receiving signals and for user gesture detection via antenna impedance. That is, user gesture impedance measurements for detecting user gestures may be done using the same (e.g., existing) antennas, and may not need any additional antennas (which would take up additional limited physical space) to operate.

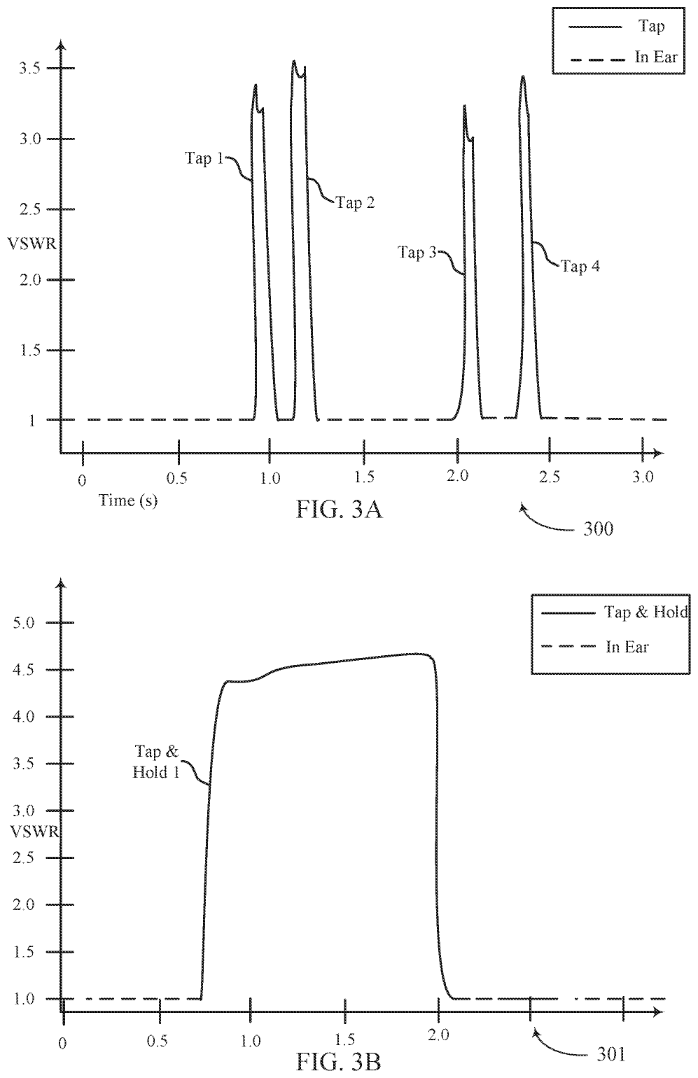

Wearable device 215 may determine antenna impedance variations based on a baseline antenna impedance value and an impedance monitoring system, as described herein. The baseline antenna impedance value may be the value (e.g., antenna tuning) at which antenna 220 is matched for optimal performance in a particular environment (e.g., use case). The matching information may be obtained in a variety of ways, including voltage standing wave ratio (VSWR) detection, a complex impedance detector circuit, or the like, which can be interpreted by wearable device 215. When a user gesture causes a mismatch or variation between the baseline antenna impedance value and a current measured antenna impedance value, then a signature may be created to identify likely root causes of the variation. For instance, a first type of variation from the baseline antenna impedance value may be associated with a first user gesture (e.g., a tap) a second variation from the baseline antenna impedance value may be associated with a second user gesture (e.g., a tap-and-hold motion), a third variation from the baseline antenna impedance may be associated with a third user gesture (e.g., a swiping motion), etc. Each signature may be defined by one or more parameters. For instance, a signature may be defined by the extent of detuning, multiple frequencies or frequency offsets, broadening of detuning in addition to a shift of matching frequency, an amount of time of detuning, and the like. Non-limiting illustrative examples of gestures and corresponding variations of antenna impedance are described in further detail with respect to FIGS. 3A and 3B. For instance, multiple frequencies or frequency offsets may refer to a shape of a detuning over frequency. In some cases, de-tuning may occur using more than one antenna based on a user input (e.g., touch). In such examples, the one or more parameters may include a pattern of antenna detuning across the set of multiple antennas (e.g., near ultra-low energy field (NULEF) antennas, long-term evolution (LTE) antennas, or the like). The multiple antennas may include, in some examples, antennas working at different operating frequencies or within the same frequency range. An antenna impedance baseline and variation from the baseline on an antenna, another antenna, or a set of antennas, may improve detuning detection (and user gesture detection) for an earbud.

Baseline antenna impedance values may be associated with difference use cases. For instance, wearable device 215 may determine a first baseline antenna impedance value for the use case in which wearable device 215 is charging, a second baseline antenna impedance value for the use case in which wearable device 215 is being moved by user 205 (e.g., from the charging case to the ear of user 205, or from the ear of user 205 to the charging case), and a third baseline antenna impedance value for the use case in which wearable device 215 is inserted into the ear of user 205. Wearable device 215 may detect user gestures in each of the use cases based on antenna impedance variations from the corresponding baseline antenna impedance value. That is, changing detected levels of antenna impedance variation from baseline (reference) antenna impedance values create patterns. The patterns may be assigned to user gestures, such as input, output, tap, tap-and-hold, vertical swipe, horizontal swipe, removal from charging station, etc.

Using antenna impedance to detect or confirm user gestures may be beneficial because it is more reliable, more flexible, and more ergonomic. For instance, a button or sensor-based system of user gesture detection may require the user 205 to apply pressure to the button, pushing wearable device 215 into the ear of user 205. Not only are such user gestures unreliable, they may also be uncomfortable to user 205. Using antenna impedance to detect or confirm user gestures may be more accurate and more comfortable for user 205. Additionally, using antenna impedance to detect or confirm user gestures may result in power savings at wearable device 215, due to more efficient user interface.

Baseline antenna impedance values may be preconfigured (e.g., factory settings). In some examples, baseline antenna impedance values may be dynamically determined. For instance, over time, wearable device 215 may identify different baseline antenna impedance values (e.g., based on consistent measurements of antenna impedance during one or more time periods) for different use cases (e.g., charging, moving, in the ear of user 205, etc.). Dynamic determination of baseline antenna impedance values may be more accurate, as they may be based on specific users 205. In some examples, baseline antenna impedance values may be initially preconfigured, but may then be dynamically adjusted over time to be more accurate or more specific to a user 205. In some cases, beginning with a preconfigured baseline antenna impedance value for each use case and dynamically adjusting the preconfigured baseline antenna impedance values may result in refining the baseline antenna impedance values faster than dynamically adjusting baseline antenna impedance values without an initial set of preconfigured values.

Device 215 may detect antenna impedance variations via active or passive scanning. For instance, in a passive scanning example, wearable device 215 may monitor current antenna impedance (e.g., VSWR values). Upon detecting a variation of antenna impedance from the baseline antenna impedance value to a currently measured antenna impedance value (e.g., a signature antenna impedance offset corresponding to a user gesture), wearable device 215 may identify a user gesture, and may update an operation status based thereon. In an active scanning example, wearable device 215 may perform one or more impedance compensation actions. For instance, wearable device 215 may adjust its transmit or receive power settings to compensate for a change in impedance. Upon detecting such compensating actions, wearable device 215 may determine that the antenna impedance has changed from the baseline, and may detect a user gesture based thereon.

Examples of user gestures that trigger antenna impedance variations from baseline antenna impedance values are illustrated and described with respect to FIGS. 3A and 3B.

FIG. 3A illustrates an example of a user gesture 300 that supports antenna usage as a user interface in accordance with aspects of the present disclosure. In some examples, user gesture 300 may implement aspects of wireless communication system 100.

In some examples, as described in greater detail with respect to FIG. 2, a device 215 may monitor for and detect antenna impedance variations from a baseline antenna impedance. In the non-limiting illustrative example of 3A, the baseline antenna impedance value may correspond to the scenario in which the wearable device 215 is in the ear of a user 205. In such examples, the baseline antenna impedance value may be a VSWR of 1 or about 1.

In some cases, a user 205 may perform a user gesture, such as a tapping motion. When user 205 taps the device 215, measured antenna impedance may change. For instance, at or around 1 second, user 205 may perform tap 1 on wearable device 215. In some examples, user 205 may perform a double tap (e.g., including tap 1 and tap 2). In some examples, a single tap (e.g., within a threshold amount of time) may correspond to a first user input, and a double tap within a threshold amount of time may correspond to a second user input, increasing the flexibility of wearable device 215 and the number of actions that can be performed without using unreliable buttons at wearable device 215 by user 205. Similarly, at or around two seconds, the user 205 may perform another tap (e.g., tap 3) or another double tap (e.g., including tap 3 and tap 4).

The wearable device 215 may measure the detuning of the antenna 220 (e.g., may detect the jump from a VSWR of about 1 to a VSWR of about 3.5). Such variations may be identified and stored by wearable device 215. That is, wearable device 215 may know that, when wearable device 215 is in the ear of user 205, the expected antenna impedance for an antenna 220 corresponds to a VSWR of about 1. Device 215 may also be aware of a predefined or dynamically determined variation in VSWR measurements, phase variations, or the like (e.g., a signature variation in antenna impedance) that occurs when a particular user gesture is made. For instance, device 215 may detect a jump from a VSWR of about 1 to a VSWR of about 3.5 for a single tap, as shown with respect to FIG. 2. In some examples, device 215 may detect a phase variation (e.g., one or more phase variations over time) to discriminate impedance variation. Upon detecting the signature variation in antenna impedance, wearable device 215 may determine that user 205 has performed a tap, and may update the operational status of wearable device 215 accordingly. For instance, in response to detecting the user gesture, wearable device 215 may turn on, turn off, activate a microphone, send or receive wireless signals, adjust a volume or other setting, or the like.

In some examples, antenna impedance monitoring may be used to confirm a user gesture hypothesis. For instance, wearable device 215 may determine that a user has tapped wearable device 215 based on sensor inputs detected at a sensor 210 (e.g., by detecting sensor inputs at an accelerometer). Then, wearable device 215 may monitor for and detect tap 1 based on the change in VSWR at about 1 second, and may confirm the hypothesis (e.g., determine with a high degree of accuracy that user 205 did tap wearable device 215. Different antenna impedance variations may correspond to different user gestures, as illustrated with respect to FIG. 3B.

FIG. 3B illustrates an example of a user gesture 300 that supports antenna usage as a user interface in accordance with aspects of the present disclosure. In some examples, user gesture 300 may implement aspects of wireless communication system 100.

In some examples, as described in greater detail with respect to FIG. 2, a device 215 may monitor for and detect antenna impedance variations from a baseline antenna impedance. In the non-limiting illustrative example of 3A, the baseline antenna impedance value may correspond to the scenario in which the wearable device 215 is in the ear of a user 205. In such examples, the baseline antenna impedance value may be a VSWR of 1 or about 1. As described in greater detail with respect to FIG. 2, different environments and scenarios may correspond to different baseline antenna impedance values.

In some cases, a user 205 may perform a user gesture, such as a tap-and-hold motion. When user 205 taps the device 215, measured antenna impedance may change. For instance, at or around 0.75 second, user 205 may initiate tap-and-hold 1 on wearable device 215. The detuning of antenna 220 when user 205 places a finger on wearable device 215 may persist for the duration of the touch. Thus, tap-and-hold 1 may result in an increase in antenna impedance (e.g., from a VSWR of about 1 to a VSWR of about 4.5) and may endure until user 205 removes the finger from wearable device 215, at which time the antenna impedance will revert to the expected baseline antenna impedance value. For instance, upon touching wearable device 215 at about 0.75 seconds, the antenna impedance may increase, and may stay at the heightened antenna impedance value (e.g., a VSWR of about 4.5) until the user 205 removes the finger at about 2 seconds. The persistence of the de-tuning of antenna 220 that occurs during tap-and-hold 1 may allow for a press-to-talk voice UI interface, which may be highly sensitive. Because of the high sensitivity of the antenna 220 to antenna impedance due to touch, the user 205 may be able to perform the tap-and-hold gesture without having to press wearable device 215 into the ear, which would result in discomfort for the user. The duration of a touch may not be detectable at sensor 210 (e.g., an accelerometer) and thus antenna impedance monitoring may lead to improved user experience and improved services (e.g., increased number of actions that can be taken by user 205) by wearable device 215.

The wearable device 215 may measure the detuning of the antenna 220 (e.g., may detect the jump from a VSWR of about 1 to a VSWR of about 4.5). Such variations may be identified and stored by wearable device 215. That is, wearable device 215 may know that, when wearable device 215 is in the ear of user 205, the expected antenna impedance for an antenna 220 corresponds to a VSWR of about 1. Wearable device 215 may also be aware of a predefined or dynamically determined variation in VSWR measurements (e.g., a signature variation in antenna impedance) that occurs when a particular user gesture is made (e.g., a jump from a VSWR of about 1 to a VSWR of about 3.5 for a single tap, or jumps to 3.5 or 4.5 and stays there for a tap-and-hold gesture). Upon detecting the signature variation in antenna impedance, wearable device 215 may determine that user 205 has performed a tap-and-hold gesture, and may update the operational status of wearable device 215 accordingly.

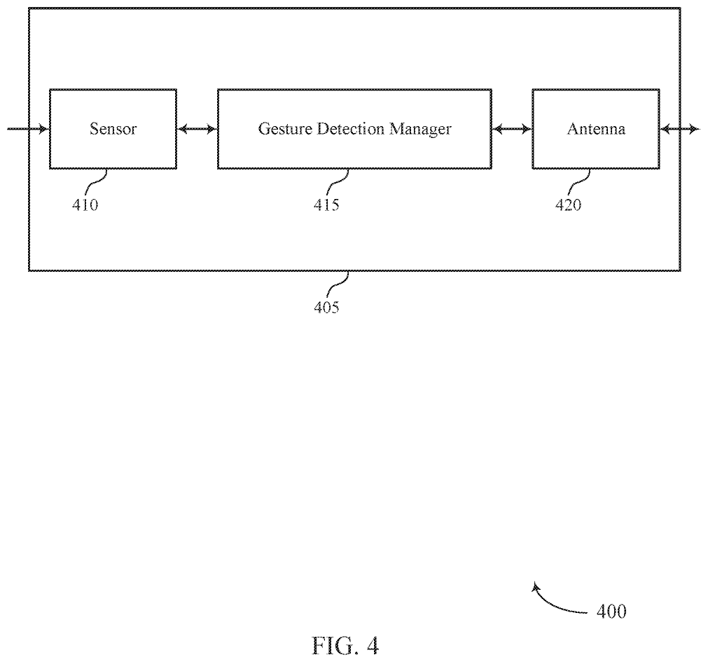

FIG. 4 shows a block diagram 400 of a wearable device 405 that supports antenna usage as a user interface in accordance with aspects of the present disclosure. The device 405 may be an example of aspects of a wearable device 115 or 215 as described herein. The device 405 may include a sensor 410, a gesture detection manager 415, and an antenna 420. The device 405 may also include a processor. Each of these components may be in communication with one another (e.g., via one or more buses).

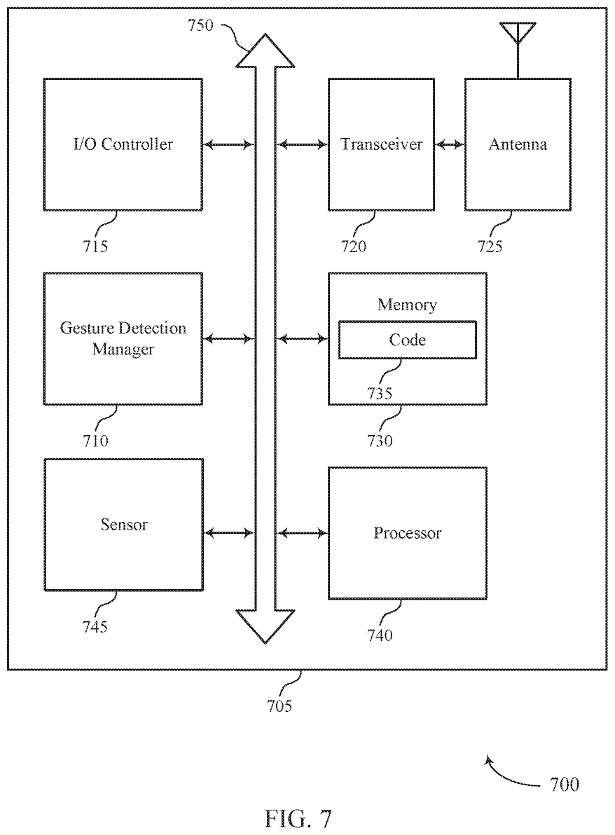

The sensor 410 may be an accelerometer, a gyroscope, a motion sensor, a proximity detector, a light sensor, or the like. The sensor 410 may detect sensor inputs at wearable device 405. For instance, sensor 410 may detect sound waves, light waves, motion, rotation, acceleration, etc. Information may be passed on to other components of the device 405. The sensor 410 may be an example of aspects of the sensor 745 described with reference to FIG. 7.

The gesture detection manager 415 may identify a baseline antenna impedance value, detect one or more sensor inputs at the device, monitor, based on the detecting, for a variation from the baseline antenna impedance value, identify, based on the detecting and the monitoring, at least one user gesture, and update an operational status of the device based on the detected user gesture. The gesture detection manager 415 may be an example of aspects of the gesture detection manager 710 described herein. In some examples, gesture detection manager 415 may determine, based on one or more sensor inputs detected by sensor 410, a user gesture hypothesis. Gesture detection manager 415 may detect antenna impedance measured by antenna confirmation of the user gesture from 420, and may confirm the user gesture hypothesis based thereon.

The gesture detection manager 415, or its sub-components, may be implemented in hardware, code (e.g., software or firmware) executed by a processor, or any combination thereof. If implemented in code executed by a processor, the functions of the gesture detection manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The gesture detection manager 415, or its sub-components, may be physically located at various positions, including being distributed such that portions of functions are implemented at different physical locations by one or more physical components. In some examples, the gesture detection manager 415, or its sub-components, may be a separate and distinct component in accordance with various aspects of the present disclosure. In some examples, the gesture detection manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The antenna 420 may transmit or receive one or more signals. In some examples, the antenna 420 may be collocated with a sensor 410 in a single module. For example, the antenna 420 may be an example of aspects of the transceiver 720 described with reference to FIG. 7. The antenna 420 may utilize a single antenna or a set of antennas. Antenna 420 may monitor for and measure antenna impedance. Antenna 420 may detect antenna impedance variations (e.g., from a baseline antenna impedance value). Gesture detection manager 415 may receive the antenna impedance variation information from antenna 420, and may determine a user gesture based thereon, or may confirm a user gesture hypothesis based thereon.

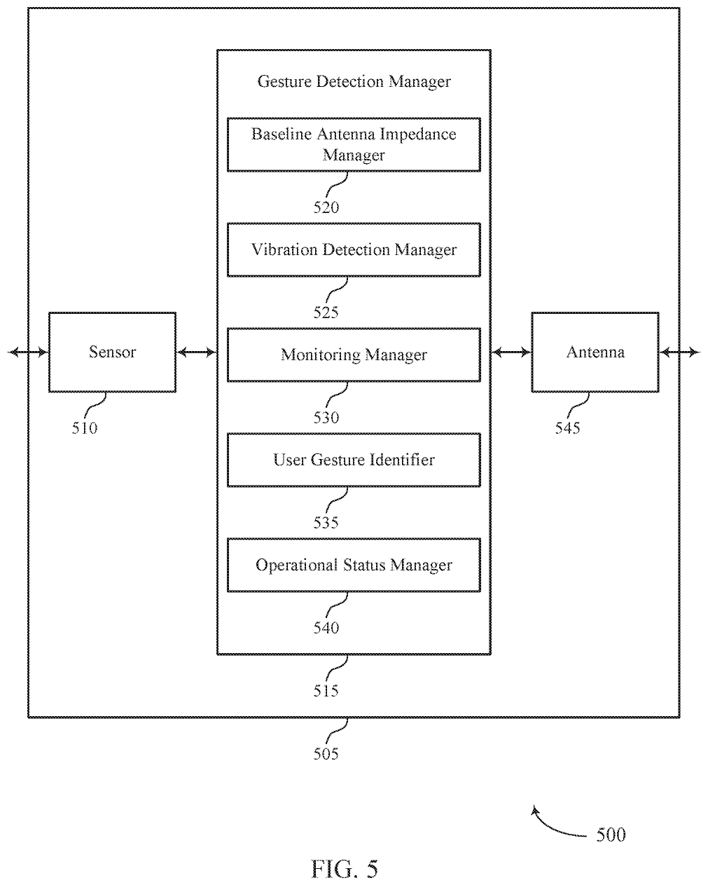

FIG. 5 shows a block diagram 500 of a wearable device 505 that supports antenna usage as a user interface in accordance with aspects of the present disclosure. The device 505 may be an example of aspects of a wearable device 115, a wearable device 215, or a wearable device 405 as described herein. The device 505 may include a sensor 510, a gesture detection manager 515, and an antenna 545. The device 505 may also include a processor. Each of these components may be in communication with one another (e.g., via one or more buses).

The sensor 510 may be an accelerometer, a gyroscope, a motion sensor, a proximity detector, a light sensor, or the like. The sensor 510 may detect sensor inputs at wearable device 505. Information may be passed on to other components of the wearable device 505. The sensor 510 may be an example of aspects of the sensor 745 described with reference to FIG. 7.

The gesture detection manager 515 may be an example of aspects of the gesture detection manager 415 as described herein. The gesture detection manager 515 may include a baseline antenna impedance manager 520, a sensor input detection manager 525, a monitoring manager 530, an user gesture identifier 535, and an operational status manager 540. The gesture detection manager 515 may be an example of aspects of the gesture detection manager 710 described herein.

The baseline antenna impedance manager 520 may identify a baseline antenna impedance value. The sensor input detection manager 525 may detect one or more sensor inputs at the device. The monitoring manager 530 may monitor, based on the detecting, for a variation from the baseline antenna impedance value. The user gesture identifier 535 may identify, based on the detecting and the monitoring, at least one user gesture. The operational status manager 540 may update an operational status of the device based on the detected user gesture.

The antenna 545 may transmit and receive signals generated by other devices, other sources, or components of the device 505. In some examples, the antenna 545 may be collocated with a sensor 510. For example, the antenna 545 may be an example of aspects of the transceiver 720 described with reference to FIG. 7. The antenna 545 may utilize a single antenna or a set of antennas. Antenna 545 may monitor and measure antenna impedance for device 505.

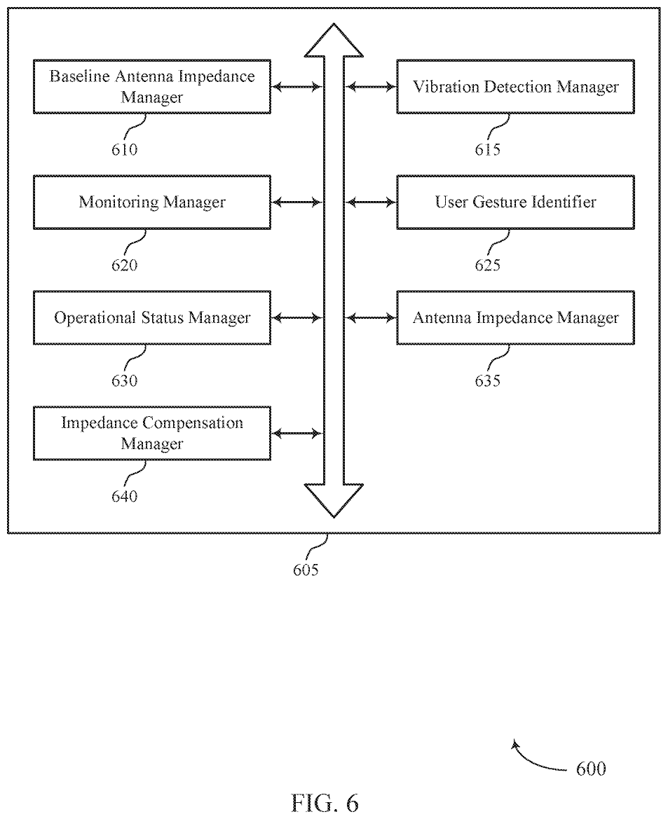

FIG. 6 shows a block diagram 600 of a gesture detection manager 605 that supports antenna usage as a user interface in accordance with aspects of the present disclosure. The gesture detection manager 605 may be an example of aspects of a gesture detection manager 415, a gesture detection manager 515, or a gesture detection manager 710 described herein. The gesture detection manager 605 may include a baseline antenna impedance manager 610, a sensor input detection manager 615, a monitoring manager 620, an user gesture identifier 625, an operational status manager 630, an antenna impedance manager 635, and an impedance compensation manager 640. Each of these modules may communicate, directly or indirectly, with one another (e.g., via one or more buses).

The baseline antenna impedance manager 610 may identify a baseline antenna impedance value. In some examples, the baseline antenna impedance manager 610 may identify a preconfigured baseline antenna impedance value. In some examples, the baseline antenna impedance manager 610 may adjust the preconfigured baseline antenna impedance value based on the one or more antenna impedance measurements.

The sensor input detection manager 615 may detect one or more sensor inputs at the device. In some examples, the sensor input detection manager 615 may detect one or more of an audio input, a physical touch, a rotation, or an acceleration, using one or more of a microphone, a speaker, a sensor, a gyroscope, or an accelerometer.

The monitoring manager 620 may monitor, based on the detecting, for a variation from the baseline antenna impedance value. In some examples, transmit one or more radio frequency signals using a first antenna, where the monitoring is based on the first antenna, where the monitoring includes measuring a current antenna impedance value for the first antenna.

The user gesture identifier 625 may identify, based on the detecting and the monitoring, at least one user gesture. In some examples, the user gesture identifier 625 may identify, based on the detecting, a user gesture hypothesis. In some examples, the user gesture identifier 625 may confirm, based on the monitoring, the user gesture hypothesis. In some examples, the user gesture identifier 625 may determine that the one or more antenna impedance compensation actions indicate a change in a current measured antenna impedance, where identifying the one or more user gesture is based on the determining. In some cases, the one or more user gesture includes one or more of a tapping motion, a tap-and-hold motion, inputting the device (e.g., inserting the device into the user's ear), removing the device (e.g., from a charging case or from the user's ear), a vertical swipe, or a horizontal swipe.

The operational status manager 630 may update an operational status of the device based on the detected user gesture (e.g., pausing music in response to a tap).

The antenna impedance manager 635 may compare the current antenna impedance value to the baseline antenna impedance value, where identifying the at least one user gesture is based on the comparing. In some examples, the antenna impedance manager 635 may perform one or more antenna impedance measurements during a period of time at a first antenna to dynamically identify the baseline antenna impedance value. In some examples, the antenna impedance manager 635 may perform one or more antenna impedance measurements during a period of time. In some examples, the antenna impedance manager 635 may perform one or more antenna impedance measurements, where identifying the one or more user gesture is based on the one or more antenna impedance measurements.

The impedance compensation manager 640 may detect one or more antenna impedance compensation actions taken by the device. In some cases, the one or more antenna impedance compensation actions taken by the device include an adjusted power setting at the device.

FIG. 7 shows a diagram of a system 700 including a wearable device 705 that supports antenna usage as a user interface in accordance with aspects of the present disclosure. The wearable device 705 may be an example of or include the components of wearable device 115, wearable device 215, wearable device 405, wearable device 505, or another device as described herein. The wearable device 705 may include components for bi-directional voice and data communications including components for transmitting and receiving communications, including a gesture detection manager 710, an I/O controller 715, a transceiver 720, an antenna 725, memory 730, and a processor 740. These components may be in electronic communication via one or more buses (e.g., bus 750).

The gesture detection manager 710 may identify a baseline antenna impedance value, detect one or more sensor inputs at the device, monitor, based on the detecting, for a variation from the baseline antenna impedance value, identify, based on the detecting and the monitoring, at least one user gesture, and update an operational status of the device based on the detected user gesture.

The I/O controller 715 may manage input and output signals for the wearable device 705. The I/O controller 715 may also manage peripherals not integrated into the wearable device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the wearable device 705 via the I/O controller 715 or via hardware components controlled by the I/O controller 715.

The transceiver 720 may communicate bi-directionally, via one or more antennas, wired, or wireless links. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wearable device 705 may include a single antenna 725. However, in some cases the device may have more than one antenna 725, which may be capable of concurrently transmitting or receiving multiple wireless transmissions. Antenna 725 may monitor antenna impedance.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory army using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting antenna usage as a user interface).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

Sensor 745 may detect user gestures, and may send that information to gesture detection manager 710 for performing a user gesture hypothesis.

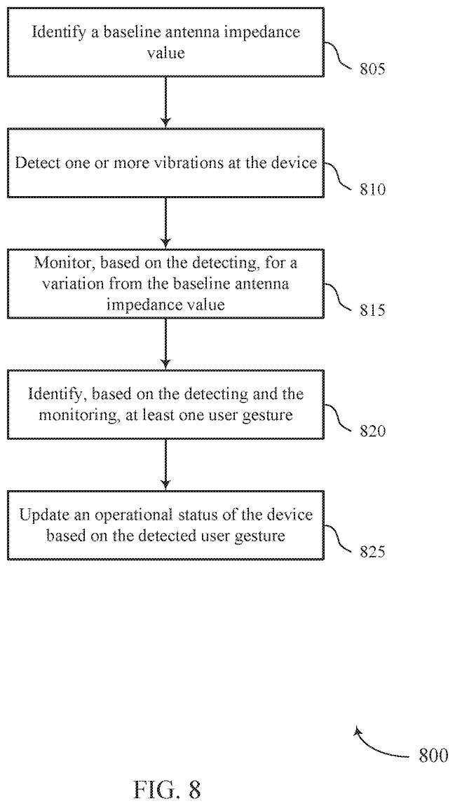

FIG. 8 shows a flowchart illustrating a method 800 that supports antenna usage as a user interface in accordance with aspects of the present disclosure. The operations of method 800 may be implemented by a wearable device or its components as described herein. For example, the operations of method 800 may be performed by a gesture detection manager as described with reference to FIGS. 4 through 7. In some examples, a wearable device may execute a set of instructions to control the functional elements of the wearable device to perform the functions described below. Additionally, or alternatively, a wearable device may perform aspects of the functions described below using special-purpose hardware.

At 805, the wearable device may identify a baseline antenna impedance value. The operations of 805 may be performed according to the methods described herein. In some examples, aspects of the operations of 805 may be performed by a baseline antenna impedance manager as described with reference to FIGS. 4 through 7.

At 810, the wearable device may detect one or more sensor inputs at the device. The operations of 810 may be performed according to the methods described herein. In some examples, aspects of the operations of 810 may be performed by a sensor input detection manager as described with reference to FIGS. 4 through 7.

At 815, the wearable device may monitor, based on the detecting, for a variation from the baseline antenna impedance value. The operations of 815 may be performed according to the methods described herein. In some examples, aspects of the operations of 815 may be performed by a monitoring manager as described with reference to FIGS. 4 through 7.

At 820, the wearable device may identify, based on the detecting and the monitoring, at least one user gesture. The operations of 820 may be performed according to the methods described herein. In some examples, aspects of the operations of 820 may be performed by a user gesture identifier as described with reference to FIGS. 4 through 7.

At 825, the wearable device may update an operational status of the device based on the detected user gesture. The operations of 825 may be performed according to the methods described herein. In some examples, aspects of the operations of 825 may be performed by an operational status manager as described with reference to FIGS. 4 through 7.

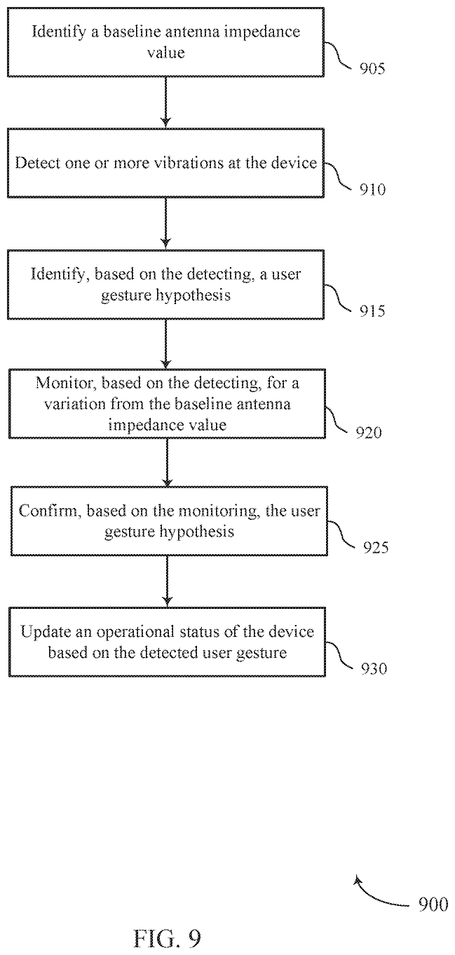

FIG. 9 shows a flowchart illustrating a method 900 that supports antenna usage as a user interface in accordance with aspects of the present disclosure. The operations of method 900 may be implemented by a wearable device or its components as described herein. For example, the operations of method 900 may be performed by a gesture detection manager as described with reference to FIGS. 4 through 7. In some examples, a wearable device may execute a set of instructions to control the functional elements of the wearable device to perform the functions described below. Additionally, or alternatively, a wearable device may perform aspects of the functions described below using special-purpose hardware.

At 905, the wearable device may identify a baseline antenna impedance value. The operations of 905 may be performed according to the methods described herein. In some examples, aspects of the operations of 905 may be performed by a baseline antenna impedance manager as described with reference to FIGS. 4 through 7.

At 910, the wearable device may detect one or more sensor inputs at the device. The operations of 910 may be performed according to the methods described herein. In some examples, aspects of the operations of 910 may be performed by a sensor input detection manager as described with reference to FIGS. 4 through 7.

At 915, the wearable device may identify, based on the detecting, a user gesture hypothesis. The operations of 915 may be performed according to the methods described herein. In some examples, aspects of the operations of 915 may be performed by a user gesture identifier as described with reference to FIGS. 4 through 7.

At 920, the wearable device may monitor, based on the detecting, for a variation from the baseline antenna impedance value. The operations of 920 may be performed according to the methods described herein. In some examples, aspects of the operations of 920 may be performed by a monitoring manager as described with reference to FIGS. 4 through 7.

At 925, the wearable device may confirm, based on the monitoring, the user gesture hypothesis. The operations of 925 may be performed according to the methods described herein. In some examples, aspects of the operations of 925 may be performed by a user gesture identifier as described with reference to FIGS. 4 through 7.

At 930, the wearable device may update an operational status of the device based on the detected user gesture. The operations of 930 may be performed according to the methods described herein. In some examples, aspects of the operations of 930 may be performed by an operational status manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for detecting user input at a device, comprising:
identifying a baseline antenna impedance value;
detecting one or more sensor inputs at the device;
monitoring, based at least in part on the detecting, for a variation from the baseline antenna impedance value;
identifying, based at least in part on the detecting and the monitoring, at least one user gesture; and
updating an operational status of the device based at least in part on the detected user gesture.

2. The method of claim 1, wherein identifying the at least one user gesture comprises:
identifying, based at least in part on the detecting, a user gesture hypothesis; and
confirming, based at least in part on the monitoring, the user gesture hypothesis.

3. The method of claim 1, further comprising:
transmitting one or more -radio frequency signals using a first antenna, wherein the monitoring is based on the first antenna, wherein the monitoring comprises measuring a current antenna impedance value for the first antenna; and
comparing the current antenna impedance value to the baseline antenna impedance value, wherein identifying the at least one user gesture is based at least in part on the comparing.

4. The method of claim 1, wherein identifying the baseline antenna impedance value further comprises:
performing one or more antenna impedance measurements during a period of time at a first antenna to dynamically identify the baseline antenna impedance value.

5. The method of claim 1, wherein identifying the baseline antenna impedance value further comprises:
identifying a preconfigured baseline antenna impedance value.

6. The method of claim 5, further comprising:
performing one or more antenna impedance measurements during a period of time; and
adjusting the preconfigured baseline antenna impedance value based at least in part on the one or more antenna impedance measurements.

7. The method of claim 1, wherein monitoring for the variation from the baseline antenna impedance value comprises:
performing one or more antenna impedance measurements, wherein identifying the one or more user gesture is based at least in part on the one or more antenna impedance measurements.

8. The method of claim 1, wherein monitoring for the variation from the baseline antenna impedance value comprises:
detecting one or more antenna impedance compensation actions taken by the device; and
determining that the one or more antenna impedance compensation actions indicate a change in a current measured antenna impedance, wherein identifying the one or more user gesture is based at least in part on the determining.

9. The method of claim 8, wherein the one or more antenna impedance compensation actions taken by the device comprise an adjusted power setting at the device.

10. The method of claim 1, wherein detecting the one or more sensor inputs comprises:
detecting one or more of an audio input, a physical touch, a rotation, or an acceleration, using one or more of a microphone, a speaker, a sensor, a gyroscope, or an accelerometer.

11. The method of claim 1, wherein the one or more user gesture comprises one or more of a tapping motion, a tap-and-hold motion, inserting the device, removing the device, a vertical swipe, or a horizontal swipe.

12. An apparatus for detecting user input at a device, comprising:
a processor,
memory coupled with the processor; and
instructions stored in the memory and executable by the processor to cause the apparatus to:
identify a baseline antenna impedance value;
detect one or more sensor inputs at the device;
monitor, based at least in part on the detecting, for a variation from the baseline antenna impedance value;
identify, based at least in part on the detecting and the monitoring, at least one user gesture; and
update an operational status of the device based at least in part on the detected user gesture.

13. The apparatus of claim 12, wherein the instructions to identify the at least one user gesture are executable by the processor to cause the apparatus to:
identify, based at least in part on the detecting, a user gesture hypothesis; and
confirm, based at least in part on the monitoring, the user gesture hypothesis.

14. The apparatus of claim 12, wherein the instructions are further executable by the processor to cause the apparatus to:
the instructions to transmit one or more radio frequency signals using a first antenna, wherein the monitoring is based on the first antenna, wherein the monitoring are executable by the processor to cause the apparatus to measure a current antenna impedance value for the first antenna; and
compare the current antenna impedance value to the baseline antenna impedance value, wherein identifying the at least one user gesture is based at least in part on the comparing.

15. The apparatus of claim 12, wherein the instructions to identify the baseline antenna impedance value further are executable by the processor to cause the apparatus to:
perform one or more antenna impedance measurements during a period of time at a first antenna to dynamically identify the baseline antenna impedance value.

16. The apparatus of claim 12, wherein the instructions to identify the baseline antenna impedance value further are executable by the processor to cause the apparatus to:
identify a preconfigured baseline antenna impedance value.

17. The apparatus of claim 16, wherein the instructions are further executable by the processor to cause the apparatus to:
perform one or more antenna impedance measurements during a period of time; and
adjust the preconfigured baseline antenna impedance value based at least in part on the one or more antenna impedance measurements.

18. The apparatus of claim 12, wherein the instructions to monitor for the variation from the baseline antenna impedance value are executable by the processor to cause the apparatus to:
perform one or more antenna impedance measurements, wherein identifying the one or more user gesture is based at least in part on the one or more antenna impedance measurements.

19. The apparatus of claim 12, wherein the instructions to monitor for the variation from the baseline antenna impedance value are executable by the processor to cause the apparatus to:
detect one or more antenna impedance compensation actions taken by the device; and
determine that the one or more antenna impedance compensation actions indicate a change in a current measured antenna impedance, wherein identifying the one or more user gesture is based at least in part on the determining.

20. An apparatus for detecting user input at a device, comprising:
means for identifying a baseline antenna impedance value;
means for detecting one or more sensor inputs at the device;
means for monitoring, based at least in part on the detecting, for a variation from the baseline antenna impedance value;
means for identifying, based at least in part on the detecting and the monitoring, at least one user gesture; and
means for updating an operational status of the device based at least in part on the detected user gesture.
